(19) United States
(12) Patent Application Publication
(10) Pub. No.: US 2026/0150992 A1
(43) Pub. Date: Jun. 4, 2026

(54) MULTIFUNCTIONAL DIGITAL DEVICE FOR WORSHIP

(71) Applicant: Edward Chandri Subiakto, Jakarta (ID)

(72) Inventor: Edward Chandri Subiakto, Jakarta (ID)

(21) Appl. No.: 19/406,903

(22) Filed: Dec. 2, 2025

(30) Foreign Application Priority Data
Dec. 3, 2024 (ID) P00202414238

(51) Int. Cl. A47G 33/00; G06F 1/16; G06F 3/0488

(52) U.S. Cl. CPC A47G 33/008; G06F 1/163; G06F 3/0488

(57) ABSTRACT

A multifunctional digital device that can be transformed into various forms that can be changed easily as well as various functions that are related to one function to the others as one package for worship in Muslims, namely for dhikr, rak'ah counter with light and vibration indicators, rak'ah counter, and salah guidance. If salah is religion's pillar and obligatory, then this invention which has the function of guiding salah is very important and useful, especially for beginners because they can learn themselves at any time without having to wait for help from others. Apart from that, other supporting functions such as rak'ah counter make it easier for the user not to have to concentrate on counting the rak'ah. The essence is for this multifunctional digital device to become a part of daily needs for worship for Muslims.

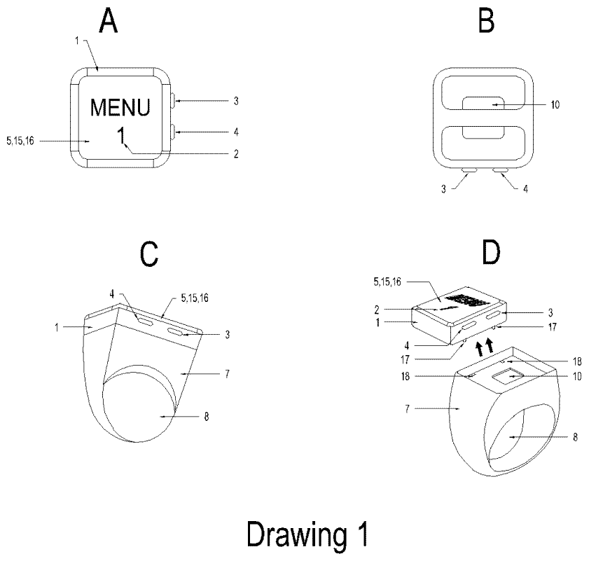

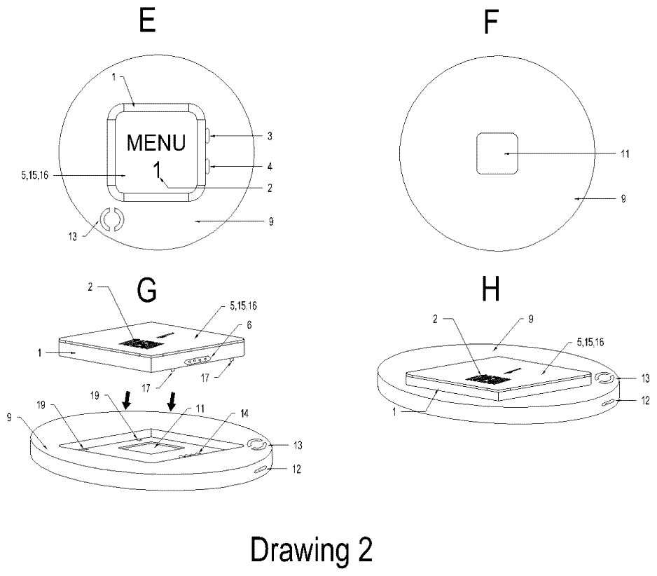

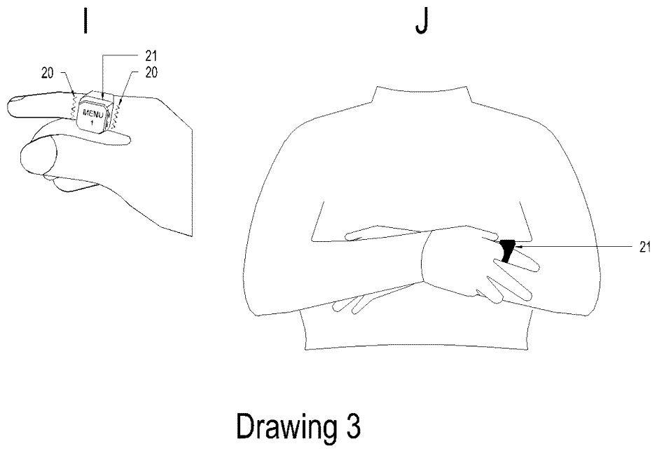

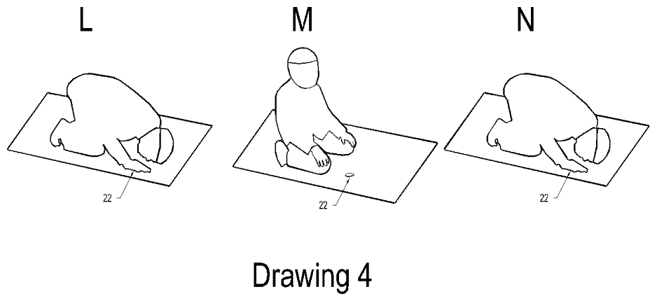

### FIELD OF INVENTION

This invention relates to a multifunctional digital device in rectangular shape and thin that can be transformed into 3 (three) separated parts which has various functions that can be used for worship especially for all Muslims. More specifically, this multifunctional digital device when worn in the finger can be used for dhikr, as well can be used for salah as rak'ah counter with lighting and vibrating indicators, and as rak'ah counter digital device which is positioned on the right or left upper prayer mat where the right or left palm is expected to touch the prayer mat when carrying out the salah ritual movements, and has an audio function via loudspeaker to play the reading guide of salah as learning for beginners such as preschoolers and converts and is equipped with chanting of verses from the Koran and prayers which is very easy to operate with simple or uncomplicated buttons and menus.

### BACKGOUND OF INVENTION

For Muslims, reciting dhikr is an activity that is highly recommended to strengthen faith and devotion to ALLAH Subhanahu Wa Ta'ala, and is compulsory for salah, which is the second position in the pillars of Islam. Digital devices for reciting dhikr or tasbih digital and rak'ah counter devices currently on the market are sold individually or separately, so they are not economical and practical. There are various digital devices that have been invented to be used as a solution to overcome the forgetfulness in rak'ah counting during salah, from those that are practical or not, from those that stand alone or not, from those that are in the form of application or not, from those that are expensive or not, and from those that are big or small. All of them have their respective advantages and disadvantages. Available in the form of a proximity sensor which is placed near the user's head or chest where inconsistencies often occur in the total counting number of rak'ah due to the detection sensitivity which relies on physical distance sensing which can fickle during prostration. This inconsistency becomes a problem rather than a solution itself which resulted the user becomes reluctant to use it out of frustration. There are also large and small prayer mats with buttons on the head or hand which are not practical to carry around when using them. Apart from that, in how to operate also with features that are quite confusing for users.

U.S. Pat. No 7,508,316-B1 (Raed Arrar) reveals an interactive electronic prayer counter that indicates a current or completed Rakah of a plurality of Rakat performed by a user during an Islamic ceremonial prayer includes a display for indicating a prayer Rakah count, a first proximity sensor for sensing when a Sudjood position has been assumed by the user, and a processor operably associated with the indicator and first proximity sensor for updating the indicator to the next Rakah. In this manner, the user is informed of his or her progress during the Islamic ceremonial prayer. The first proximity sensor is capable of sensing the Sudjood position without physical contact by the user. A second proximity sensor can also be provided to detect a particular stage of the prayer cycle for updating the display.

U.S. Pat. No 6,783,822-B1 (Hassan Faouaz) reveals a Muslim prayer counter comprising a short upper edge and a parallel shrot lower edge with ling parallel side edges there between, the rug having an exposed planar upper surface and a lower surface adapted to be supported on a floor; a counter secured to the upper surface of the carper adjacent the upper edge in proximity to one side edge thereof; a switch located on the upper surface of the carper mid-way between side edge; a battery secured to the lower surface of the rug adjacent the upper in proximity to the counter, the battery including an electrical lines coupling the counter and the battery and the switch.

Indonesian Patent IDS00003058 (Pandji A. Dwizra) reveals an aid device in the form of Head Prayer Mat Rak'ah Counter which has sensors that are sensitive to head pressure during prostration in the form of prostration pad; an electronic circuit that uses battery power to count the total number of rak'ahs and shows it through illuminated display of numbers, easy to read even in a dark room.

Indonesian Patent S00202110480 (application) registered on Nov. 22, 2021 in the name of the Applicant Sultan Agung Islamic University (Semarang) with the title SMART PRAYER MAT reveals the smart prayer mat media to emphasize more on the concept that functions to enter information into the toddler's brain through touch movements and correcting the position of body parts, so that it can help toddlers in performing salah.

Indonesian Patent S00202212250 (application) registered on Oct. 31, 2022 in the name of Applicant Budi Luhur University (Cileduk, Tangerang) with the title PRAYER MAT WITH RAK'AH COUNTER reveals a prayer mat for salah that is small in size is followed by using Arduino to control other devices arranged on a Breadboard with pushbutton and display light (10 segment LED).

Indonesia Paten IDS000006911 (Edward Chandri Subiakto) reveals a Sachet-Pouch Digital Rak'ah Counter is a digital aid device to recall the total number of rak'ah so that not to forget at the same time without interfering with the user solemnity when salah. This invention also has materials that are soft and pleasant when pressed by the user's right or left palm with a consistent and soundless counting button, and has a display that is not glare but easy to read in both light and dark conditions, this device is also equipped with recordings of Asmaul Husna and Juz Amma in its memory, and is equipped with speaker ability as loudspeaker and a ‘bluetooth’ ability as a wireless connection.

Indonesia Paten IDP000037335 (Edward Chandri Subiakto) reveals a digital counting device in the form of one embodiment comprising a contour holder connected to a ‘T’ shaped button and to a pair of grasping fingers with the assist of an ‘X’ spring hinge and a pair of ‘Y’ spring hinges respectively. A large ‘A’ button, a large ‘B’ button, a large ‘C’ button, and a large ‘D’ button are located in each corner of its shape. In addition, this digital counting device has a small button ‘time duration’ on the top left, a small button ‘count-group’ on the top right, a small button ‘count-minus’ on the bottom left, and a small button ‘reset/light’ on the bottom right of the LCD. The LCD is used as a screen with backlight when activated, it has a red backlight to indicate counting in ‘odd’ numbers and a blue backlight to indicate counting in ‘even’ numbers. The letter ‘T’ shaped button has two parts consisting of a vertical part and a horizontal part, where each part has its own function.

Indonesia Paten IDP000047743 (Edward Chandri Subiakto) reveals a mini device (called Fix-smart), with an adjustable and rotating ring band worn on the user's finger, which constitutes of one body, consisting of a voice recorder, mp3/mp4 with radio, loudspeaker, USB connection base, microphone, bluetooth, Micro SD slot, light lamp, indicator light, and 4 digital counters, with color LCD to select operation menus by pressing buttons with a single thumb, which can record, playback, and count to help the users increase and improving their learning abilities, which is called ‘innovative learning methods’, by recording, listening, checking and repeating of what is being learned for educational and religious purposes.

Because of the things mentioned above with the idea of improving the existing ideas, this invention reveals a multifunctional digital device that is related to one another in one package that is inseparable for Muslims worship which has four important functions namely for dhikr, rak'ah counter with lighting and vibrating indicators, rak'ah counter, and salah guidance. This multifunctional digital device is very practical and simple to operate, as well as small and thin and portable so that users can carry it anywhere at an economical price so that it is affordable for all levels of society.

### BRIEF DESCRIPTION OF INVENTION

This invention relates to a practical multifunctional digital device that is small and thin in rectangular shape. This multifunctional digital device is made with a series of technological electronics that are already available on the market with a touch screen for displaying number countings and menus which can simultaneously be used as a button that can be swiped up, down, right or left with one finger. This multifunctional digital device can be easily detached and attached with a simple ‘clip’ mechanism design onto the ring frame which has 3 (three) sizes of hole that is small, medium and large. Likewise, it can be easily detached and attached to a rounded docking station that contains an mp3, speaker, vibrator and (rechargeable) battery. As a result, 2 (two) digital device products are created that can ‘interexchangable’ between each other yet have 4 (four) different functions for carrying out activities namely dhikr, rak'ah counter with lighting and vibrating indicators, rak'ah counter, and salah guidance. Apart from that, these 2 (two) digital devices are very easy to operate, and the advantage when transformed into a dhikr digital device or tasbih digital is that the button in the form of a touch screen only needs to be swiped so it will not make the user's finger get fatique quickly if done tens of thousands of times which is different from the tasbih digital on the market today. As well, when transformed to rak'ah counter digital device, this mutifunctional digital device is placed by the user at the location where the user's right or left palm is assumed to be positioned when prostrating during a salah ritual. The user's right or left palm acts as a button pusher to count the total number of rak'ah. In addition, this multifunctional digital device has button and menu which is simple or not complicated, and equipped with battery that can be recharged without having to replace the battery therefore making it more economical and practical. In accordance with what has been described, this is what makes this multifunctional digital device more superior to the other dhikr digital devices or rak'ah counters.

To facilitate the explanation of the illustrated drawings, there are important points as follows:
(1) Digital Module
(2) Menu/Number
(3) Mode 1 Button
(4) Mode 2 Button
(5) Touch Screen
(6) Female Connector
(7) Ring Frame
(8) Ring Hole
(9) Dock Station
(10) Ring Frame Hole
(11) Dock Station Hole
(12) Type-C Connector
(13) Loudspeaker Outlet
(14) Male Connector
(15) White Backlight
(16) Green Backlight
(17) Male Flexible Hook Tooth
(18) Female Groove Ring Frame
(19) Female Groove Dock Station
(20) Vibrator
(21) Rak'ah Tasbih Device
(22) Salah Learning Device

### BRIEF DESCIPTION OF DRAWINGS

This invention is better understood with the following detailed explanations. Such descriptions make reference to the drawings attached here:

Drawing 1 (A, B, C, D) illustrates a top view, bottom view, perspective view and view of multifunctional digital device separated from the ring frame in accordance to the present

Drawing 2 (E, F, G, H) illustrates a top view, bottom view, view 4 multifunctional digital device attached to the dock station and perspective view in accordance with the present invention.

Drawing 3 (I, J) illustrates the appearance of multifunctional digital device placed in the user's right hand on the index finger and the appearance of multifunctional digital device positioned in the user's right hand when crossing arms in accordance with this invention.

Drawing 4 (L, M, N) illustrates the usage position of multifunctional digital device during worship in accordance with the position of this invention.

### DETAILED DESCRIPTION OF INVENTION

Multifunctional digital device invention consists of the following specifications:
I. Rectangular shape or other shapes that is small and thin which can be stored in the user's pocket.
II. Counting of rak'ah number is based on touching the touch screen with the palm of the right or left hand when prostrating, where the prostration is done 2 (two) times for each increment of 1 (one) rak'ah in the case of Obligatory, Sunnah or Tarawih Salah.
III. Counting of number for dhikr is done with one finger by sliding the surface of the touch screen in up, down, right or left direction in accordance to the user ease.
IV. Counting of total number can be seen on the screen as a lighted display with large number so that can be easily read by all ages in bright or dark conditions without dazzling the user's eyes.
V. Transformation from dhikr digital device to counting rak'ah digital device can be carried out with an easy and simple ‘clip’ mechanism, making it multi-beneficial and convenient for user.
VI. There are 3 (three) ring frame sizes, namely small, medium and large, so that user has the option to adjust the placement on which finger to make it more comfortable.
VII. There are mp3 and loudspeaker that function to intonate the reading in Salah for guidance for beginners such as preschoolers and converts.
VIII. There is a wireless connection namely ‘Bluetooth’ for connecting or ‘pairing’ with gadgets such as smartphone, laptop, tablet and the like.

The illustrations of Drawing 1 and Drawing 2 are seen on the Digital Module (1) which has Touch Screen (5) with simultaneously functions to display Menu/Number (2) where on the top right side there is Mode 1 Button (3), on the lower right side there is Mode 2 Button (4), and on the left side there is Female Connector (6). This Digital Module (1) can be attached to the Ring Frame (7) which has Ring Hole (8) with 3 (three) different sizes, namely small, medium and large, with ‘clip’ mechanism, and can be separated by pressing upwards with the index finger at the location where Ring Frame Hole (10) is. Once separated from the Ring Frame (7), this Digital Module (1) which has Female Connector (6) can be then attached to the Dock Station (9) which has Male Connector (14) so that the two connectors can be linked to one another, with ‘clip’ mechanism also. On the middle left side of the Dock Station (9) there is a Type-C Connector (12) for charging or data transfer, and on the top surface there is Loudspeaker Outlet (13) so that audio can be heard clearly. To separate the Digital Module (1) from the Dock Station (9), there is Dock Station Hole (11) where the user can press upwards with the index finger at that location.

This invention consists of 3 (three) parts: Digital Module (1), Ring Frame (7), and Dock Station (9). Each of these three parts is made in such a way that is based on specifications I to VIII mentioned above.

The operation method of this invention is shown in Drawing 1 and Drawing 3 with the following explanation:

To be used as dhikr digital device and counting rak'ah digital device with lighting and vibrating indicators, the Digital Module (1) which has 4 (four) Male Flexible Hook Tooth (17) can be attached with ‘clip’ mechanism to the Ring Frame (7) which has 4 (four) Female Groove Ring Frame (18) with 3 (three) different sizes, namely small, medium and large, which certainly depends on the size of the user's finger and can be placed on any finger according to user wishes. As a result, by combining the two, a transformation occurs into a digital device called Rak'ah Tasbih Device (21) which the user can then press the Mode 1 Button (3) for 3 (three) seconds to turn on so that Menu/Number (2) can be seen on the Touch Screen (5) which next step to be taken is function selection which is displayed in the form of 2 (two) options, namely ‘Tasbih’ and ‘Indicator’. If selected ‘Tasbih’, will function as dhikr digital device in general namely doing dhikr in increment of 1 (one) number from 0 to 99999, and has Vibrator (20) feature if i it is idle for 3 (three) minutes will vibrate to remind doing dhikr again so that not forgotten. To reset again, the user can press and hold Mode 2 Button (4) until the number 0 (zero) is visible. Different in operation from dhikr digital device on the market, the surface of this Touch Screen (5) can be simply swiped in up, down, right or left direction, without having to press, in accordance to the user comfort so that the finger do not get tired easily if doing dhikr in thousands of times. Simultaneously, those total numbers can be seen in the Menu/Number (2) which the display light can be adjusted by pressing and holding Mode 1 Button (3) to maximize or vice versa by pressing and holding Mode 2 Button (4) to minimize in accordance to user comfort but can be seen clearly in daylight or in dark places.

If selected ‘Indicator’, will function as counting rak'ah digital device with lighting and vibrating indicators. Because of sometimes too solemn or not concentrating conversely when praying, user generally often forgets when counting in the 3rd or 4th rak'ah, therefore is recommended to do the Sahwi prostration to fulfill the rak'ah which results in the imperfection of the salah. To overcome this as a solution, before performing salah according to the illustration of ‘Usage’ I, the Digital Module (1) which has been previously installed into the Ring Frame (7) to become a Rak'ah Tasbih Device (21) which can be worn by the user through the Ring Hole (8) which size is adjusted to the index finger with the position of the Touch Screen (5) facing towards the thumb where in Islamic law it is permissible to wear a ring that is not made of gold when salah. During each salah cycle for 1 (one) rak'ah occurs 1 (one) ‘Crossing Arms’ J, namely where the right hand is placed on top of the left hand while holding it, where concurrently the thumb is needed to slide once on the surface of the Touch Screen (5) upwards or downwards according to the user comfort to count the number of rak'ah with lighting and vibrating indicators. In its operation, for example, during the obligatory Dhuhr, Asr or Isha salah which have 4 (four) rak'ah, when the user starts by performing takbiratul ihram, namely “ALLAAHUAKBAR” then ‘Crossing Arms’ J for first time where concurrently the thumb slides the surface of the Touch Secreen (5) downwards once where Menu/Number (2) will display number 1 (one) or odd number with White Backlight (15) as the counting of 1st rak'ah, then when ‘Crossing Arms’ J for second time where concurrently the thumb slides the surface of the Touch Screen (5) downwards once where Menu/Number (2) will display number 2 (two) or even number with Green Backlight (16) as the counting of 2nd rak'ah, then when ‘Crossing Arms’ J for third time where concurrently the thumb slides the surface of the Touch Screen (5) downwards once where Menu/Number (2) will display number 3 (three) or odd number with White Backlight (15) as the counting of 3rd rak'ah, then when ‘Crossing Arms’ J for fourth time where concurrently the thumb slides the surface of the Touch Screen (5) downwards once where Menu/Number (2) will display number 4 (four) or even number with Green Backlight (16) as the counting of 4th rak'ah. This is where the benefit is if getting used to it, namely by sliding the thumb on the surface of the Touch Screen (5) upwards or downwards once according to the user comfort every time ‘Crossing Arms’ J, when the user forgets which rak'ah is being counted, the user can realize what color of the light it is, namely white for odd or green for even as an indicator without having to glance or look at the number because glancing or seeing is not allowed which results in invalid salah where the gaze is required to remain focused on the location where the forehead will be placed when in prostration position later. However, there is an exception or it is recommended to look at the index finger when it is lifted in the 2nd and last rak'ah. Only at this time can the user look at the Menu/Number (2) which has been positioned in such a way when first worn according to the illustration of ‘Usage’ I, to remind the user what number or color it is if forgotten. In line with this function, if Mode 1 Button (3) is pressed simultaneously with Mode 2 Button (4), it will activate Vibrator (20) where Rak'ah Tasbih Device (21) will vibrate 1 (one) time when in odd number or odd rak'ah as an indicator other than the White Backlight (15), also vibrate 2 (two) times with a duration of 2 (two) seconds interval between vibrations when in even number or even rak'ah as an indicator other than the Green Backlight (16) which is especially for visually impaired users. This is the main purpose of this invention to count the rak'ah with lighting and vibrating indicators so that user can see a flash of white or green light in front or at the corner of the eyes without having to glance or look by feeling the vibrations too during performing salah which beneficial when forget or loose concentration can realize instantly so as not to miscalculate which rak'ah it is, namely odd or even. To adjust the White Backlight (15) and Green Backlight (16) according to the user desire for comfort when performing salah, the Mode 1 Button (3) can be pressed continuously to maximize the brightness of the light or vice versa, the Mode 2 Button (4) can be pressed continuously to minimize the brightness of the light. There is an easy ‘clip’ open-install mechanism design without the help of any tools where user can separate the Digital Module (1) from the Ring Frame (7) by pressing upwards with index finger at the location of Ring Frame Hole (10).

The operation method of this invention is shown in drawing 2, 3 and 4 with the following explanation:

To be used as rak'ah counting digital device, or with the option of rak'ah counting while simultaneously performing salah guidance reading for beginners, the Digital Module (1) which has 4 (four) Male Flexible Hook Tooth (17) can be attached to a round Dock Station (9) the size of which is smaller than an adult palm that does not have right-angled curves that can interfere with the comfort of the user which has 4 (four) Female Groove Dock Station (19). In addition, there is Female Connector (6) in the Digital Module (1) which can be embedded together with Male Connector (14) in the Dock Station (9) so that the two connectors is linked to each other. In its transformation when the two are combined with ‘clip’ mechanism become a digital device called the Salah Learning Device (22) which is equipped with an mp3 and a loudspeaker whose purpose is to recite readings for guidance in salah. In addition, functions as a rak'ah counting device so that user does not forget the rak'ah when performing the obligatory salah, especially those consisting of 4 (four) rak'ah and is also useful for Tarawih which have more rak'ah than obligatory salah, namely 11 (eleven), 13 (thirteen) and even 23 (twenty-three) rak'ah. Because this Salah Learning Device (22) is specifically designed for the purpose of learning salah alone without the help of others in correcting so that can be fluent in the recitation of the reading, then before using it as a salah guidance reading, user who is beginner must first learn and understand the physical movements in salah and listen to the recitation of the readings on the Salah Learning Device (22) repeatedly without salah first as to memorize them, like learning to memorize song lyrics by listening to them which of course will be faster than memorizing song lyrics by reading the writings.

By pressing Mode 1 Button (3) for 3 (three) seconds to turn on as such Menu/Number (2) is visible on the Touch Screen (5) which displays the options ‘Learn’, ‘Pray’, and ‘Counter’. I chosen ‘Learn’, will display the options for the obligatory salah of Fajr, Dhuhr, Asr, Maghrib and Isha, along with the choice of Qari (Quran reader) so that can be selected for the speed of the recitation according to user wishes. According to what is selected, the number 0 (zero) will be visible on the Touch Screen (5) therewith the reading of recitation for salah's intention at that choice. Then the user places Salah Learning Device (22) at the appropriate location as wishes where instinctively the right palm will be placed at the prostration position later. Shortly after that is heard the chanting of salah reading starting with takbiratul ihram, namely “ALLAAHUAKBAR”, simultaneously followed by the process of ‘Crossing Arms’ J while imitating the chanting that is read as guidance of which the speed can be adjusted from the beginning of selection with certain Qari. When starting from this takbiratul ihram, the user conscientiously follows the process of the salah ritual while chanting the reading aloud to be more fluent even correcting any mistakes if any. When in the illustration position of ‘1^{st} Prostration’ L, user presses the Touch Screen (5) with right palm which functions as button to count the rak'ah simultaneously button to do ‘pause’ so that the user does not have to rush or take the time as wishes in this prostration position as the chanting of the salah reading will stop for a moment until the user does the illustration position of ‘Sitting’ M with both eyes still focused at the forehead expectedly will touch the ground, then the chanting of the reading will continue again. Next, when taking the illustration position of ‘2^{nd} Prostration’ N where the user prostrates again with Salah Learning Device (22) precisely in the right hand's palm. As done before, the user can prostrate according to the time as wishes. This feature of ‘pause’ is essential because generally user wants to do more praying when prostrating in the last rak'ah of salah. After this illustration position of ‘2^{nd} Prostration’ N, the counting of rak'ah will increase by 1 (one) number which is displayed in the Menu/Number (2) with the number “1” (one).

According to the description above, namely Drawing 4 constitutes of ‘1 (one) cycle’ in salah related to the usage of Salah Learning Device (22) which is pressed by the user's right palm onto the Touch Screen (5) as button when prostrating 2 (two) times to assist in counting the number of rak'ah displayed in Menu/Number (2) to show each increment of 1 (one) rak'ah. Each obligatory and sunnah salah has ‘1 (one) cycle’ which occurs continuously so that this Salah Learning Device (22) can count the number of rak'ah from number “1” (one) to number “4” (four) depending on which salah option is selected initially.

When selecting ‘Pray’, will display the options for daily prayers' readings and Asmaul-Husna chanting where after being selected can play the audio of that choice through Loudspeaker Outlet (13). By pressing Touch Screen (5) for 3 (three) seconds, will reset to the beginning of the selection. If Salah Learning Device (22) is not used for 20 (twenty) minutes, will turn off itself to save battery, and simply pressing the Touch Screen (5) again will turn back on. There is Type-C Connector (12) to recharge the battery with electric power without having to buy button batteries which are not economical and sometimes not easy to find in general.

When selecting ‘Counter’, there are options consisting of ‘2’, ‘3’, ‘4’, ‘11’, ‘13’ and ‘23’ which indicates that it functions as a digital rak'ah counting device according to the number of rak'ah desired by the user. Those numbers represent the number of rak'ah in Sunnah, Obligatory and Tarawih salah. After being selected, the user can carry out salah ritual process as should be, where first placing Salah Learning Device (22) at the location according to the user wishes where instinctively the right palm will be placed in the prostration position later. The uniqueness of this function also, if the Digital Module (1) is released from the Dock Station (9) using the index finger by pushing up on the Dock Station Hole (11), the Digital Module (1) can also work independently without having to use the Dock Station (9).

It is understood that the process described above can be realized as an invention as a multifunctional digital device that can be transformed into various forms and functions but related to each other as one package, especially useful for Muslims in worshipping. In addition, has buttons and menus that are prepared as simple as possible in its operation and its advantages can be easily slipped into a pocket so that it can be carried by the user anywhere.

The foregoing description of the present invention has been presented for illustrative and explanatory purposes. Of course in this case must be understood that what described is not limited to what is stated above. Consequently, all variations and modifications that may be made by the experts to this Multifunction Digital Device For Worship as described are understood to be within the scope of the present invention as set out in the following claims.

1. A multifunctional digital device for worship which consists of:
digital module (1) which has touch screen (5) to display the menu/number (2), where on the upper right side there is mode 1 button (3), on the lower right side there is mode 2 button (4) and on the left side there is female connector (6), a ring frame (7) as a framework for embedding the digital module (1) which has;
ring hole (8) with 3 (three) different sizes, namely small, medium and large, and a ring frame hole (10) as a hole for pushing the digital module (1) during the separation operation by pressing upwards using the index finger, and rounded shape dock station (9) the size of which is smaller than the palm of an adult hand which does not have a right-angled curve that can interfere with user comfort which is equipped with;
male connector (14) as coupling to the female connector (6) of the digital module (1) so that the two connectors can be linked to each other,
type-C connector (12) for charging or data transfer, and loudspeaker outlet (13) as audio output can be heard clearly, dock station hole (11) as means of separating the digital module (1) from the dock station (9) by inserting the user's index finger through the hole to push the digital module (1) upwards, which is characterized by the digital module (1) being equipped with;
4 (four) male flexible hook tooth (17) placed at each corner as a means of connecting to the ring frame (7) which has female groove ring frame (18) or dock station (9) which has female groove dock station (19) with easy and simple ‘clip’ mechanism for transformation from digital dhikr device to digital rak'ah counter device thus creating multiple benefits and is comfortable for the user,
white backlight (15) and green backlight (16) and vibrator (20) are used as rak'ah counting indicator, where;
white light as well as 1 (one) time vibration indicate odd rak'ah, and green light as well as 2 (two) times vibration indicate even rak'ah with an interval of 2 (two) seconds, mode 1 button (3) to activate/deactivate the device by pressing for 3 (three) seconds and the menu/number (2) will appear on the touch screen (5) as well as displaying the menu options ‘Learn’, ‘Pray’, and ‘Counter’.

2. A multifunctional digital device for worship as in claim 1, where the digital module (1) is further configured as rak'ah counter with the option of rak'ah counter which is accompanied by simultaneously conducting salah guidance with reading chants for beginners with the aim of being able to memorize them and simultaneously correcting them in order to achieve perfection in worship.

3. A multifunctional digital device for worship as in claim 1 and claim 2, where the digital module (1) is further configured as rak'ah counter that can stand alone or be independent without having to be attached to the ring frame (7) or to the dock station (9) so that it can be pocketed and can be taken anywhere for use.
